(19) United States
(12) Patent Application Publication
(10) Pub. No.: US 2024/0348177 A1
(43) Pub. Date: Oct. 17, 2024

(54) SWITCHING POWER SUPPLY, CONTROLLER THEREFOR AND IMPROVEMENTS THEREOF

(71) Applicant: Champion Microelectronic Corporation, Hsinchu (TW)

(72) Inventor: Jeffrey Hwang, Saratoga, CA (US)

(21) Appl. No.: 18/630,906

(22) Filed: Apr. 9, 2024

Related U.S. Application Data
(60) Provisional application No. 63/528,621, filed on Jul. 24, 2023.
(60) Provisional application No. 63/459,453, filed on Apr. 14, 2023.

(51) Int. Cl. H02M 7/219; H02M 1/42

(52) U.S. Cl. CPC H02M 7/219; H02M 1/4208

(57) ABSTRACT

A switching power supply comprises a first power supply stage configured to receive an AC input voltage and to generate a DC output voltage, wherein the DC output voltage of the first power supply stage is set to a first target level during a light load condition and, otherwise, the output voltage is set to a second target level, the second target level being lower than the first target level.

This application claims priority of U.S. Ser. No. 63/459,453, filed Apr. 14, 2023, and U.S. Ser. No. 63/528,621, filed Jul. 24, 2023. The entire contents of the aforementioned applications are hereby incorporated by reference.

### BACKGROUND OF THE INVENTION

The present invention relates to the field of switching power supplies.

An off-line power supply receives power from an alternating-current (AC) source and provides a voltage-regulated, direct-current (DC) output that can be used to power a load. An exemplary off-line power supply includes a power factor correction (PFC) stage and a DC-to-DC converter stage. The PFC stage receives the AC input signal, performs rectification and maintains current drawn from the AC source substantially in phase with the AC voltage so that the power supply appears as a resistive load to the AC source. The DC-to-DC converter stage receives the rectified output of the PFC stage and generates the voltage-regulated, DC output which can be used to power the load. The rectified output of the PFC stage is typically at higher voltage and is more loosely regulated than the output of the DC-to-DC stage.

It is desired to provide an improved switching power supply.

### SUMMARY OF THE INVENTION

The present invention is directed toward a switching power supply and improvements thereof. In accordance with an embodiment, a switching power supply is provided. The switching power supply comprises a first power supply stage configured to receive an AC voltage and to generate a DC output voltage. The output voltage is set to a first target level during a light load condition and, otherwise, the output voltage is set to a second target level, the second target level being lower than the first target level. The second target level may be dependent upon a level of the AC voltage source provided as input to the switching power supply. The first power supply stage may comprise a PFC stage. The switching power supply may include a second power supply stage. If so, the second power supply stage is configured to receive the DC output voltage of the PFC stage and to generate a further DC output voltage. The DC output voltage of the second power supply stage is lower than the DC output voltage of the first power supply stage.

These and other embodiments are described herein.

### BRIEF DESCRIPTION OF THE DRAWINGS

The present invention is described with respect to particular exemplary embodiments thereof and reference is accordingly made to the drawings in which:

FIG. 1 illustrates a block schematic diagram of a two-stage, off-line power supply in accordance with an embodiment of the present invention;

FIG. 2 illustrates a schematic circuit diagram of a power factor correction stage in accordance with an embodiment of the present invention;

FIG. 3 illustrates a block schematic diagram of a controller for a power factor correction stage in accordance with an embodiment of the present invention;

FIG. 4 illustrates a graph showing a relationship between AC input voltage and DC output voltage in accordance with an embodiment of the present invention; and

FIG. 5 illustrates a schematic circuit diagram of a DC-to-DC converter stage in accordance with an embodiment of the present invention.

### DETAILED DESCRIPTION OF A PREFERRED EMBODIMENT OF THE INVENTION

The present invention is directed towards an improved switching power supply. In accordance with an embodiment, a switching power supply includes at least a first power supply stage, for example, a power factor correction (PFC) stage. The switching power supply may include a second power supply stage, for example, a DC-to-DC converter stage. The first power supply stage is configured to receive an AC voltage as input and to generate a DC output voltage. The second power supply stage receives the DC output voltage of the first power supply stage and generates a further DC output voltage. The DC output voltage of the first power supply stage is set to a first target level during a light load condition and, otherwise (e.g., under a heavy load condition), the output voltage is set to a second target level. The second target level is lower than the first target level. Therefore, under light load conditions, the output of the first power supply stage is set to target level that is higher than its target level under heavy load conditions.

The second target level for the DC output voltage of the first power supply stage may be dependent upon a level of an AC voltage source provided as input to the switching power supply. For example, the effective voltage level (e.g., the root mean square or RMS value) of the AC supply voltage provided to the power supply can be monitored by the first power supply stage. The first power supply stage may then adjust the second target level according to the monitored level of the AC input voltage under heavy load conditions.

When the output voltage of the first power supply stage is set to the first target level, this can be referred to as a first mode of operation. When the output voltage of the first power supply stage is set to the second target level, this can be referred to as a second mode of operation. In the first mode of operation, the first target level is preferably a fixed value. In the second mode of operation, the second target level is preferably a variable value which is dependent upon the monitored effective voltage level of the AC supply voltage.

The DC output voltage of the first power supply stage is regulated using a negative feedback loop. The switching in the first power supply stage is controlled to increase or decrease power transferred to the output so as to regulate the output voltage. An error signal representative of a difference between the target level for the output voltage of first power supply stage and the actual value of the output voltage of first power supply stage can be used to control the power transferred to the output in the first power supply stage.

Transitioning between the first mode and the second mode can be accomplished by monitoring the error signal. When the error signal is below a threshold, this indicates light loading conditions, in which case, the power supply operates in the first mode. When the error signal exceeds a threshold, this indicates heavy loading conditions, in which case, the power supply operates in the second mode.

Changing from the first target level to the second target level, and vice versa, can result in a sudden change in the target level. When this occurs, it is expected that a transition time period will be required for the actual output voltage to reach the new target level. In an embodiment, the target level is preferably not changed again at least until the actual output voltage approaches the new target level. This can be accomplished, for example, by avoiding changing the target level again for a predetermined time period after a change in the target level or by avoiding changing the target level again until the error signal falls below a threshold after a change in the target level.

As mentioned above, under light load conditions, the first power supply stage operates in a first mode of operation. In an exemplary embodiment, the first target level may be set to, for example, 380 volts DC, in the first mode. Under these conditions, the error signal level may below a threshold of 1.0 volt. Then, should the load conditions change, the error signal may rise above the 1.0 volt threshold. When the error signal rises above the threshold, this indicates a change in the load condition from light to heavy. In response to the error signal exceeding the threshold, the first power supply stage enters a second mode of operation. In this mode, the second target level may be set to, for example, 163 volts DC or higher, but preferably not higher than the first target level which, in this example, is 380 volts DC.

The target level of 163 volts DC in the second mode of operation may correspond to the AC input supply voltage being 115 volts AC. The target level being 163 volts DC or higher ensures that that second target level is at least as high as (i.e. not lower than) the peak input voltage. It should be noted that 115 volts AC corresponds to a maximum peak sinusoidal level of approximately 163 volts. This is because 115 volts multiplied by the square root of two (or approximately 1.414) equals approximately 163 volts. If the AC input supply is 220 volts AC, the second target level may instead be set to 311 volts DC. Again, this level ensures that that second target level is at least as high as (i.e. not lower than) the peak input voltage. This is because 220 volts AC corresponds to a maximum peak sinusoidal level of approximately 311 volts (220 volts multiplied by 1.414 equals approximately 311 volts). Therefore, in this example, the second target level is dependent upon the level of the AC supply voltage and is set to a level that is at least as high as the peak level of the AC supply. The second target level is also preferably set to a level that is below the first target level. In this example, the first target level is 380 volts DC. Therefore, in this example, the second target level can, therefore, be set to a level in the range of 162 to 380 volts DC where the particular value within the range depends on the level of the AC supply voltage. The level of the AC supply voltage in this example is expected to be within a range of approximately 115 volts AC to 220 volts AC.

Operation of the switching power supply as described herein is expected to improve efficiency and transient response of the switching power supply. Energy storage capacity of an output capacitor for the first power supply stage can also be limited.

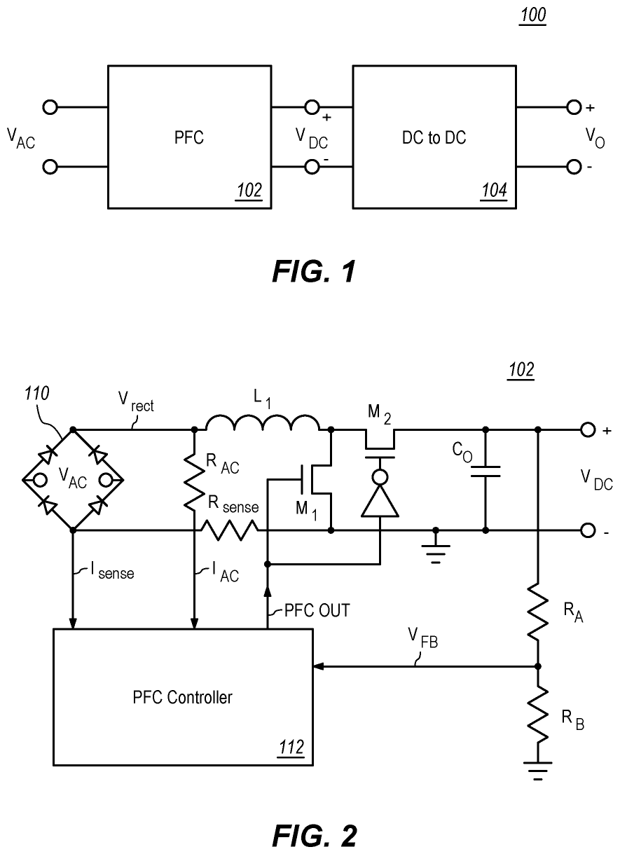

FIG. 1 illustrates a block schematic diagram of a two-stage, off-line power supply 100 in accordance with an embodiment of the present invention. As shown in FIG. 1, a first power supply stage 102 has an input coupled to alternating-current (AC) source V_{AC}. The first power supply stage 102 can be a power factor correction (PFC) stage. The PFC stage 102 performs rectification on the AC input signal and maintains current drawn from the AC source substantially in phase with the AC voltage so that the power supply 100 appears as a resistive load to the AC source. The PFC stage 102 generates a loosely regulated output voltage, V_{DC}.

The output voltage V_{DC} of the PFC stage 102 can be provided as input to a second power supply stage 104. The second power supply stage 104 can be a DC-to-DC converter stage. Using the input V_{DC}, the DC-to-DC converter stage 104 generates a voltage-regulated, DC output, V_{O}, which can be used to power a load. The level of V_{DC} is preferably at a higher voltage and can be more loosely regulated than the output V_{O} of the DC-to-DC converter stage 104. A target level of the output, V_{DC}, of the PFC stage 102 may be, for example, approximately 380 volts DC, while the voltage-regulated output V_{O} of the DC-to-DC converter stage 104 may be, for example, approximately 12.0 volts DC.

FIG. 2 illustrates a schematic circuit diagram of a power factor correction (PFC) stage 102 in accordance with an embodiment of the present invention. An alternating-current (AC) input source V_{AC} is coupled across input terminals of a bridge rectifier 110. A rectified input voltage signal Vrect is formed at a first output terminal of the rectifier 110 and is coupled to a first terminal of a main PFC inductor Li and to a first terminal of a resistor R_{AC}. A second terminal of the inductor Li is coupled to a first terminal of a transistor switch M₁ and to a first terminal of a transistor switch M₂. A second terminal of the switch M₂ is coupled to a first terminal of an output capacitor C_{O}. A second terminal of the switch M₁ and a second terminal of the capacitor C_{O} are coupled to a ground node.

A second terminal of the resistor R_{AC} is coupled to a voltage sensing input of a PFC controller 112. An input voltage sensing signal I_{AC}, which is representative of the instantaneous rectified input voltage Vrect, flows through the resistor R_{AC} and is received by the controller 112. A second output terminal of the bridge rectifier 110 is coupled to a current sensing input of the controller 112 and to a first terminal of a resistor Rsense. A second terminal of the resistor Rsense is coupled to the ground node. A current sensing signal Isense, which is representative of the instantaneous current input to the power factor correction stage 102, is formed across the resistor Rsense and is received by the controller 112.

A resistor R_{A} has a first terminal coupled to the output voltage V_{DC} and a second terminal coupled to a first terminal of resistor R_{B}. A second terminal of the resistor R_{B} may be coupled a ground node. The resistors R_{A} and R_{B} form a voltage divider. An output voltage sensing signal V_{FB} is formed at the node between the resistors R_{A} and R_{B}. The signal V_{FB} is representative of the output voltage V_{DC}.

The PFC controller 112 generates a signal PFC OUT which controls the opening and closing of the switches M₁ and M₂ so as to regulate the intermediate output voltage V_{DC} while maintaining the input current in phase with the input voltage V_{AC}. To accomplish this, the controller 112 uses the signal V_{FB}, as well as the input voltage sensing signal I_{AC} and the input current sensing signal Isense. The switches M₁ and M₂ are generally operated such that when one is opened, the other is closed.

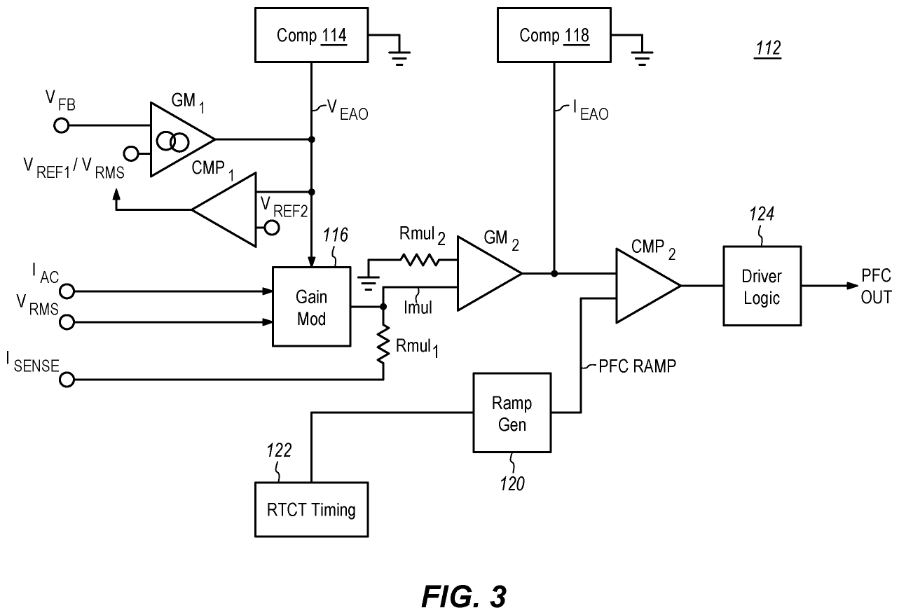

FIG. 3 illustrates a block schematic diagram of the PFC controller 112 in more detail in accordance with an embodiment of the present invention. Within the controller 112, the signal V_{FB} is coupled to a first input terminal of a transconductance error amplifier GM₁. A second input of the error amplifier GM₂ is coupled to a reference voltage that is representative of a desired level for the output voltage V_{DC}. This reference voltage may be a fixed value V_{REF1} or a variable value V_{RMS}, depending upon the output level of a comparator CMP₁. An output of the error amplifier GM₁ forms a signal V_{EAO}, which is an error signal that is representative of a difference between the actual level of the output voltage V_{DC} and a desired level for the output voltage. As shown in FIG. 3, the error signal V_{EAO} is formed across a compensation circuit 114.

In an embodiment, the level of the reference voltage V_{REF1} corresponds to a target level of 380 volts DC for the PFC output V_{DC}, while the reference voltage V_{RMS} is representative of the level of V_{AC}. For example, when the level of V_{AC} is 115 volts AC, the level of V_{RMS} may correspond to a target level of 163 volts DC for the PFC output V_{DC}. As another example, when the level of V_{AC} is 220 volts AC, the level of V_{RMS} may correspond to a target level of 311 volts DC for the PFC output V_{DC}. For these two examples, V_{AC} and V_{RMS} are proportional to V_{DC}. It will be apparent that different levels for the PFC output V_{DC} can be selected, for example, by changing the reference voltage levels applied to the error amplifier GM₁ in response to the levels of V_{RMS}. The level of V_{RMS} is therefore representative of an average value of the input voltage V_{AC} (as opposed to an instantaneous value, as is the case for I_{AC}). The signal V_{RMS} can be generated, for example, by applying the signal I_{AC}, which represents an instantaneous value of the input voltage V_{AC}, to a filter that generates signal V_{RMS} by averaging value of I_{AC} over at least one cycle of the AC input voltage V_{AC}.

In an embodiment, the comparator CMP₁ determines whether the PFC circuit 102 is operating under light load conditions or heavy loading conditions (i.e. loading conditions other than light load) according to the level of the error signal V_{EAO}. For example, when the level of the error signal V_{EAO} is less than a voltage reference V_{REF2}, this indicates light load conditions; in this case, the output of the comparator CMP₁ may be a logic low voltage. If the level of the error signal V_{EAO} exceeds V_{REF2}, this indicates heavy loading conditions; in this case, the output of the comparator CMP₁ may be a logic high voltage. In an embodiment, the voltage reference V_{REF2} may be set to 1.0 volts.

The output of the comparator CMP₁ determines whether the fixed reference voltage V_{REF1} or the variable reference voltage V_{RMS} is applied to the error amplifier GM₁. When the fixed reference voltage V_{REF1} is applied to the error amplifier GM₁, this may be referred to as a “first” mode of operation. When the variable reference voltage V_{RMS} is applied to the error amplifier GM₁, this may be referred to as a “second” mode of operation. Thus, the level at which V_{DC} is regulated by the PFC stage 102 can be different depending upon the loading.

Changing between the first and second modes of operation (i.e. changing from a first target level for the output V_{DC} to a second target level, and vice versa), can result in a sudden change in the target level for the output V_{DC}. In an embodiment, once the output of the comparator CMP₁ is changed, the reference voltage applied to the error amplifier GM₁ is preferably not changed again (i.e. from V_{REF1} to V_{RMS} or from V_{RMS} to V_{REF1}) at least until the actual output voltage approaches the new target level. This can be accomplished, for example, by avoiding changing the target level again for a predetermined time period after a change or by avoiding changing the target level again until the error signal falls below a threshold after a change. Such a delay can help to prevent unstable operation. Such a delay can be implemented, for example, by a timer circuit within the comparator CMP₁ which prevents its output from changing for a predetermined time after each change or by requiring V_{EAO} to fall below or rise above V_{REF2} by a hysteresis margin after each change in output of the comparator CMP₁.

A gain modulation block 116 receives the error signal V_{EAO} as well as the signal I_{AC} for generating a modulated error signal Imul. The gain modulation block 116 can, optionally, also receive the signal V_{RMS}. The signal V_{RMS} is representative of the level of the AC line voltage and can be used to inhibit switching in the PFC stage 102, by gradually pulling down the level of the signal Imul, for example, if the AC line voltage is too low for an extended period (i.e. under “brown out” conditions).

The output of the gain modulation block 116 is coupled to a first input terminal of a transconductance amplifier GM₂ and to a first terminal of a resistor Rmul₁. A second terminal of the resistor Rmul₁ is coupled to receive the signal Isense. A first terminal of a resistor Rmul₂ is coupled to a second input terminal of the amplifier GM₂. A second terminal of a resistor Rmul₂ is coupled to a ground node.

An output of the amplifier GM₂ is coupled to a compensation circuit 118. A signal I_{EAO} is formed at the output of the amplifier GM₂. The signal I_{EAO} is representative of the error signal V_{EAO} as well as the input voltage and input current to the PFC stage. The signal I_{EAO} is coupled to a first input of a comparator CMP₂. An output of a ramp generator 120 forms a ramp signal PFC RAMP which is coupled to a second terminal of the comparator CMP₂. An RTCT node of the ramp generator 120 is coupled to an RTCT timing network 122 which sets the frequency of the ramp signal.

The signal I_{EAO} functions to implement a first feedback loop which equalizes the signals I_{AC} and I_{SENSE} in order to maintain the input voltage Vrect in phase with the input current I_{AC}. This first feedback loop includes the signals I_{AC} and I_{SENSE}, as well as the gain modulation block 116, resistors Rmul₁ and Rmul₂, and transconductance amplifier GM₂. As a result, the PFC converter appears to the AC input source as a resistive (i.e. non-reactive) load. The signal I_{EAO} also functions to implement a second feedback loop which regulates the output voltage V_{DC} at its desired level. This second feedback loop includes the signals V_{FB} and V_{REF1} (or V_{RMS}) as well as the gain modulation block 116 and transconductance amplifiers GM₁ and GM₂

An output of the comparator CMP₂ is coupled to driver/logic block 124 which includes driver and logic circuit elements for forming the PFC switching signal PFC OUT. The signal PFC OUT controls the transistor switches M₁ and M₂ of the PFC stage 102 (FIGS. 1-2) of the switching power supply 100 (FIG. 1). It will be apparent that the PFC function and control of switching in the PFC stage 102 as shown in FIG. 3 can be accomplished in other ways and by employing different circuit arrangements.

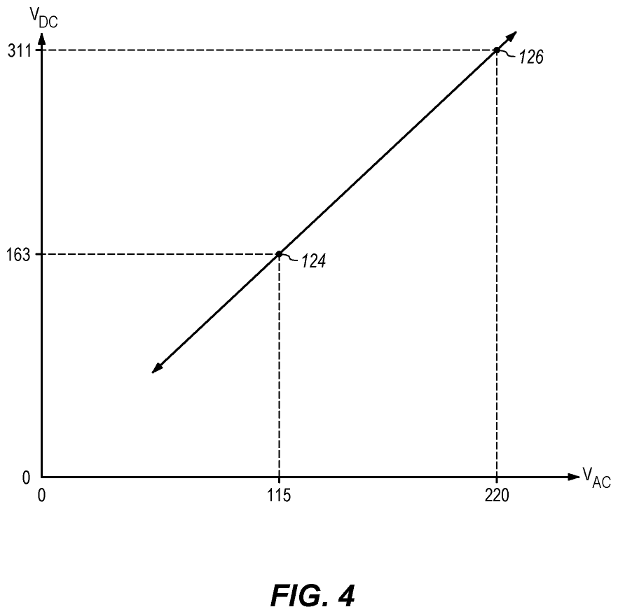

FIG. 4 illustrates a graph showing a relationship between AC input voltage V_{AC} and DC output voltage V_{DC} in accordance with an embodiment of the PFC stage 102 of the power supply 102. The relationship shown in FIG. 4 is applicable to the second mode of operation of the PFC stage 102 in which the output voltage V_{DC} is regulated at a level that is dependent upon the level of the input voltage V_{AC}.

FIG. 4 shows the following exemplary points on the graph: (1) point 124 where V_{AC} is 115 volts AC which corresponds to a level of 163 volts DC for the output voltage V_{DC}; and (2) point 126 where V_{AC} is 220 volts AC which corresponds to a level of 311 volts DC for the output voltage V_{DC}. As illustrated by the straight line and linear scales along the x-axis and y-axis of FIG. 4, the relationship between V_{AC} and V_{DC} is linear, however, it will be apparent that it is not necessary and that some other relationship, such as a non-linear relationship, could be employed.

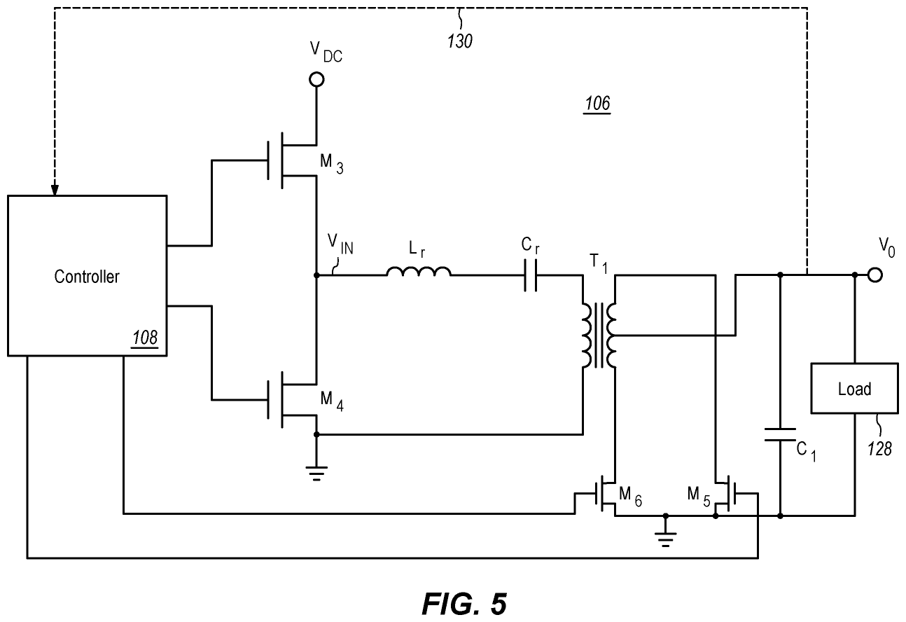

FIG. 5 illustrates a schematic diagram of a resonant switching converter 106 in accordance with an embodiment of the present invention. The resonant switching converter 106 may be, for example, included in the DC-to-DC converter 104 of FIG. 1. Referring to FIG. 5, the converter 106 includes a half-bridge switching inverter that includes a pair of series-connected transistor switches M₃ and M₄. A power source, such as the output V_{DC} generated by the PFC stage 102 (FIG. 1), is coupled to a first terminal of the transistor switch M₃. A second terminal of the transistor switch M₃ is coupled to a first terminal of a transistor switch M₄ to form an intermediate node. The second terminal of the transistor switch M₄ is coupled to a ground node. Control terminals of each of the transistor switches M₃ and M₄ are coupled to a controller 108. The controller 108 controls opening and closing of the pair of transistor switches M₃ and M₄. The switches M₃ and M₄ are generally operated such that when one is opened, the other is closed. When the switch M₃ is closed and the switch M₄ is open, the intermediate node is coupled to V_{DC}. This raises a voltage, V_{IN}, at the intermediate node. When the switch M₃ is open and the switch M₄ is closed, the intermediate node is coupled to ground. This lowers the voltage, V_{IN}, at the intermediate node.

Energy storage elements are coupled to the intermediate node. Particularly, as shown in FIG. 5, a first terminal of an inductor Lᵣ is coupled to the intermediate node. A second terminal of the inductor Lᵣ is coupled to a first terminal of a capacitor Cᵣ. The energy storage elements, Lᵣ and Cᵣ, form a series resonant tank. The resonant tank is charged with energy by raising and lowering the voltage V_{IN} at the intermediate node. A second terminal of the capacitor Cᵣ is coupled to a first terminal of a primary winding of a transformer T₁. A second terminal of the primary winding of the transformer T₁ is coupled to a ground node. A first terminal of a secondary winding of the transformer T₁ is coupled to a first terminal of a transistor switch M₅. A second terminal of the secondary winding of the transformer T₁ is coupled to a first terminal of a transistor switch M₆. A second terminal of the transistor switch M₅ and a second terminal of the transistor switch M₆ are coupled to a ground node. Control terminals of each of the transistor switches M₅ and M₆ are coupled to the controller 108. The controller 108 controls opening and closing of the transistor switches M₅ and M₆ synchronously with transistor switches M₃ and M₄.

A center tap of the secondary winding of the transformer T₁ is coupled to a first terminal of a capacitor C₁. A second terminal of the capacitor C₁ is coupled to a ground node. An output voltage, V_{O}, is formed across the capacitor C₁. A load 110 may be coupled across the capacitor C₁ to receive the output voltage V_{O}. The output voltage V_{O}, or a voltage that is representative of the output voltage, is fed back to the controller 128 via a feedback path 130.

Adjusting the switching frequency of the transistor switches M₃, M₄, M₅ and M₆ adjusts impedance of the resonant tank and, therefore, adjusts the amount of power delivered to the load 128. More particularly, decreasing the switching frequency tends to increase the power delivered to the load 128. Increasing the switching frequency tends to reduce the power delivered to the load 128. By monitoring the level of the output voltage V_{O} via a feedback path 130, the controller 108 can adjust the switching frequency to maintain the output voltage V_{O} constant despite changes in the power requirements of the load 128 and despite changes in the level of the input V_{DC}. This is referred to as frequency modulation or FM modulation. In an embodiment, the output voltage V_{O} is regulated at a level of 12.0 volts DC, however, it will be apparent that some other output voltage level can be selected. While FIG. 5 shows a half-bridge switching inverter, it can be replaced with a full-bridge switching inverter or with some other DC-to-DC converter topology.

The foregoing detailed description of the present invention is provided for the purposes of illustration and is not intended to be exhaustive or to limit the invention to the embodiments disclosed. Accordingly, the scope of the present invention is defined by the appended claims and any amendments thereto.

What is claimed is:

1. A switching power supply comprising: a first power supply stage configured to receive an AC input voltage and to generate a DC output voltage, wherein the DC output voltage of the first power supply stage is set to a first target level during a light load condition and, otherwise, the output voltage is set to a second target level, the second target level being lower than the first target level.

2. The switching power supply according to claim 1, wherein the first power supply stage performs power factor correction and further comprising a second power supply stage configured to receive the DC output voltage from the first power supply stage and the second power supply stage being configured to generate a DC output voltage for the second power supply stage.

3. The switching power supply according to claim 1, wherein the second target level for the DC output voltage of the first power supply stage is variable.

4. The switching power supply according to claim 3, wherein the first power supply stage adjusts the second target level according to a monitored level of the AC input voltage.

5. The switching power supply according to claim 4, wherein the second target level is not lower than a peak level of the AC input voltage.

6. The switching power supply according to claim 4, wherein the AC input voltage is monitored by the first power supply stage to determine the second target level.

7. The switching power supply according to claim 1, wherein the DC output voltage of the first power supply stage is regulated using a negative feedback loop and wherein an error signal representative of a difference between a current target level for the output voltage of first power supply stage the output voltage of first power supply stage is used to control switching in the first power supply stage.

8. The switching power supply according to claim 5, wherein the error signal is monitored to detect the light loading condition.

9. The switching power supply according to claim 1, wherein the first target level is approximately 380 volts DC.

10. The switching power supply according to claim 1, wherein the second target level is within a range of approximately 162 volts DC to 311 volts DC.

11. A controller for switching power supply, the controller comprising:
a power factor correction circuit arrangement configured to control a switching element to generate a regulated DC output voltage using a received AC input voltage, wherein a level of the regulated DC output voltage is variable according to a reference voltage; and
a detector circuit arrangement coupled to the power factor correction circuit arrangement and configured to detect a load condition and to control the reference voltage according to the detected load condition, wherein the output voltage of the first power supply stage is set to a first target level in response to the load condition being light and, otherwise, the output voltage is set to a second target level, the second target level being lower than the first target level.

12. The controller according to claim 11, wherein the power factor correction circuit arrangement is configured to generate an error signal wherein the error signal is representative of a difference between a current target level for the regulated DC output voltage and a monitored level of the DC output voltage.

13. The controller according to claim 12, wherein the detector circuit arrangement monitors the error signal for detecting the load condition.

14. The controller according to claim 11, further comprising a first power supply stage configured to generate the regulated DC output voltage and further comprising a second power supply stage configured to receive the DC output voltage from the first power supply stage and the second power supply stage being configured to generate a DC output voltage for the second power supply stage.

15. The controller according to claim 11, wherein the second target level for the DC output voltage is variable.

16. The controller according to claim 15, wherein the controller adjusts the second target level according to a monitored level of the AC input voltage.

17. The controller according to claim 16, wherein the second target level is not lower than a peak level of the AC input voltage.

18. The controller according to claim 17, wherein the AC input voltage is monitored by the controller to determine the second target level.

19. The controller according to claim 11, wherein the first target level is approximately 380 volts DC.

20. The controller according to claim 11, wherein the second target level is within a range of approximately 162 volts DC to 311 volts DC.
